(19) United States
(12) Patent Application Publication
(10) Pub. No.: US 2006/0144810 A1
(43) Pub. Date: Jul. 6, 2006

(54) Feed and drink bottles for babies and young children

(76) Inventor: Christopher Mallet, Marden (GB)

Correspondence Address: Robert G Lancaster;Bryan Cave, One Metropolitan Square, 211 North Broadway Suite 3600, St Louis, MI, 63102, US

(21) Appl. No.: 10/528,902

(22) PCT Filed: Sep. 19, 2003
(86) PCT No.: PCT/GB03/04039

§ 371 Date: Oct. 3, 2005

(30) Foreign Application Priority Data
Sep. 23, 2002 (GB) 0222041.6

(51) Int. Cl. A61J 11/00; B65D 21/00; B65D 85/62

(52) U.S. Cl. 215/11.1; 206/505; 206/515; 206/517

(57) ABSTRACT

A feeding bottle (10) for babies or young children is provided in stackable form. The bottle comprises components that are stackable in sets of the components. For example, a bottle comprising a container body (12) and a closure (14) therefor, might be provided as a stack of container bodies one within the other and a stack of closures on top of each other.

This invention relates to feed and drink bottles for babies and young children.

Feed bottles for babies generally comprise a container for the milk or other nutrient liquid (feed); a (natural or synthetic) rubber teat for the mouth of the container, and a screw-threaded cap to fit on the mouth to retain the teat in position. To ensure that a baby's feed is not contaminated, it is usual to sterilize the bottle before use, as by cleaning the bottle in a sterilizing liquid or using a steam sterilizer. The same needs to be done with the teat and the cap of the bottle, to ensure their sterility. However, sterilization, or even thorough cleaning of a baby's bottle, may be over looked, or carried out inadequately, causing the feed to become contaminated.

DE 2358128B discloses a bottle closure device and a complementarily formed bottle top for the sterile dispensing of flowable and/or pasty or viscous, sterile bottle contents, particularly of baby food, whereby the bottle top or its opening provided for the discharge of the contents, respectively, is covered under sterile conditions by a cover or closure wall, and said device being adapted to be attached to said bottle top and including on its inner face cutting means for the opening of said bottle, threads for threading onto the bottle top provided with complementary threads and for the simultaneous actuation of said cutting means, as well as means for the sterile dispensing or removal of the bottle contents after the opening of said bottle.

EP 0300786A discloses a one-piece combined feeding teat and cap assembly in which the mouthpiece is molded from a flexible material such as thermoplastic rubber and attached to the cap, which is molded from a different rigid material such as polypropylene. The cap can either make a snap fit or a screw fit onto a container. A method of manufacturing the one-piece combined feeding teat and cap of the invention is also disclosed.

One method of providing disposable, preferably aseptic, bottles intended for a single-use only is disclosed in EP-A-0819417, which shows a wide-mouthed bottle body having a closure snap-fitted to it, the closure nipping the periphery of a wide flange on a teat between itself and the mouth of the body. After it has been fitted, the closure cannot be removed because a curved flange on the closure denies the user access to the rim of the closure.

This known bottle suffers from serious disadvantages. One is that the bottle cannot be manufactured by known techniques, because of the reentrant angles in both the body and the flange. Even were this difficulty to be overcome, another disadvantage is that the complicated construction of the bottle would make it extremely expensive to manufacture, thus militating against users being prepared to pay so much for a single use bottle. Another disadvantage arises from the fact that the closure has to be pushed home by the user. It is inevitable that a flustered mother would sometimes push only part of the closure rim over the latching shoulder over the latching shoulder on the body, leaving the rest of the closure canted at a slight angle, which would prevent the bottle from being fluid-tight. She could be misled by the noise into thinking the closure was fully home, when only part of it was. This known ‘theoretical’ invention also is potentially dangerous to the baby, because a baby could pull the end of the teat so hard that its flange ceases to be clamped between the closure and the body, enabling the baby to pull the teat out of the bottle converting the teat into a potentially-lethal object which could suffocate the baby by becoming lodged in its windpipe. In addition, it may be possible with this bottle for the baby to deform the bottle immediately below the closure to an extent such that the fluid seal between the body and closure is broken, leading to a leakage of the liquid from the bottle, which could prove dangerous to a feeding infant.

An object of the invention is to provide a feeding bottle for babies or young children that may be provided in stackable form.

A second object of this invention is to provide a feeding bottle for babies or young children in improved sterile condition, especially for single use.

According to one aspect of the invention there is provided a feeding bottle for babies or young children provided in stackable form.

Preferably, the bottle comprises components that are stackable in sets of the components. For example, a bottle comprising a container body and a closure therefor, might be provided as a stack of container bodies one within the other and a stack of closures on top of each other. The closure component will preferably include a teat for the bottle. The teat may be a separable component, for which means for locking it in place may be included, such as a locking ring to clamp a flange of the teat between the closure and the ring. Alternatively, the teat may be bonded or co-molded to the closure. Another form of bottle according to this aspect of the invention may have the teat attached to one end of the container body in any suitable way, including those just mentioned and a closure attachable to the opposite end of the body.

A cap may be provided for protecting the teat. The cap is preferably a press-fit over the teat onto the closure or sides of the body.

In an alternative preferred embodiment of the invention the bottle may have a closure having a drinking spout, so that the bottle may be suitable for use by young children. The spout preferably has a slit for a drinking opening. The spout is preferably situated close to an edge of the closure. The closure preferably has a vent for pressure equalisation in the bottle as liquid is sucked out via the spout. The vent is preferably in the form of a slit preferably in a depression of the closure. The vent slit is preferably shorter than the slit of the drinking spout.

The spout is preferably co-moulded onto the closure. The vent is preferably also co-moulded onto the container. Ideally, a combined spout and vent component is co-moulded onto the closure. The spout, vent or the combined spout and vent component is preferably made of a thermo plastic elastomer. The closure itself may be made of polypropylene.

The closure may be a screw cap. The closure for the bottle is preferably non-removable once the bottle has been filled. A ratchet mechanism may be used, such as disclosed in our earlier patent application GB 2334518A. Alternatively, the closure may be a snap-fit onto the body and a formation may be provided on the body to inhibit removal of the closure, such as a rib or the like to inhibit levering off of the closure. The rib preferably extends outwards to be substantially coterminous with the outer extent of the closure. The closure is preferably adapted or arranged to form a fluid tight seal with the container body.

According to a second aspect of the invention there is provided a feeding bottle for babies or young children comprising a container body and a closure therefor, wherein the container body before use has a cover protecting the interior thereof.

The invention further provides a container body for a feeding bottle for babies or young children, wherein the container body before use has a cover protecting the interior thereof.

The cover preferably extends into the container body, whereby container bodies are stackable one within the other. The cover is preferably adhered to the rim of the container body at its open end.

The cover is preferably made of flexible plastics material and is preferably non-stick relative to the material of the container bodies. A suitable cover material may be polystyrene.

Preferably feeding bottles of the second aspect of the invention are also feeding bottles of the first aspect of the invention.

This invention will now be further described, by way of example only, with reference to the accompanying drawings, in which:

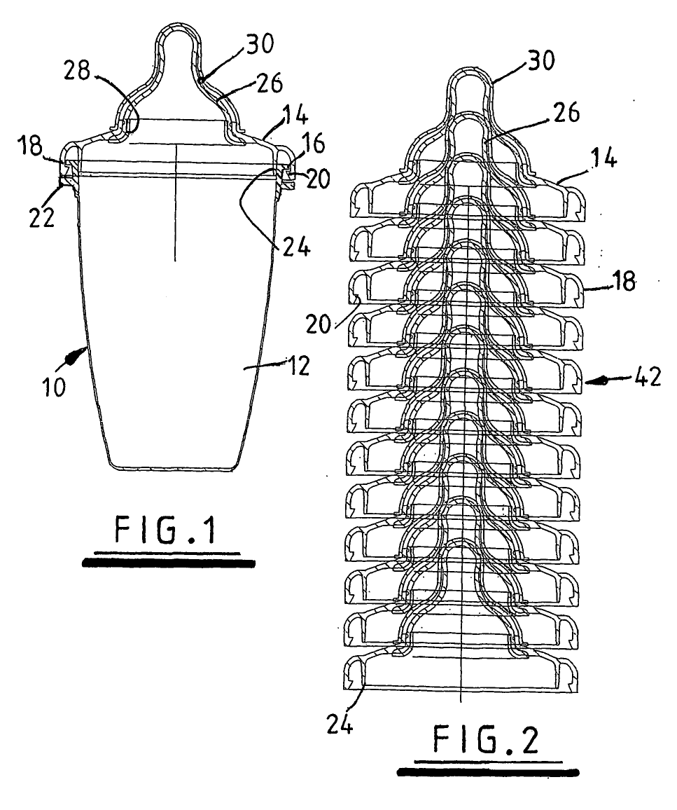

FIG. 1 shows a babies feeding bottle of the invention;

FIG. 2 shows stacking of closures for the bottle of FIG. 1;

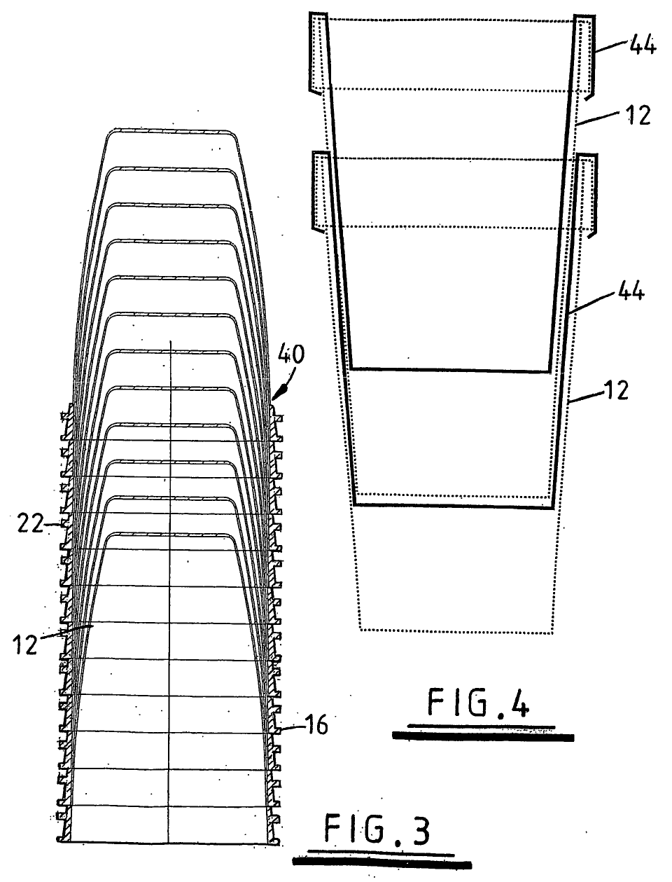

FIG. 3 shows stacking of bodies of the bottle of FIG. 1;

FIG. 4 shows schematically an alternative stacking system for bodies of the bottle of FIG. 1;

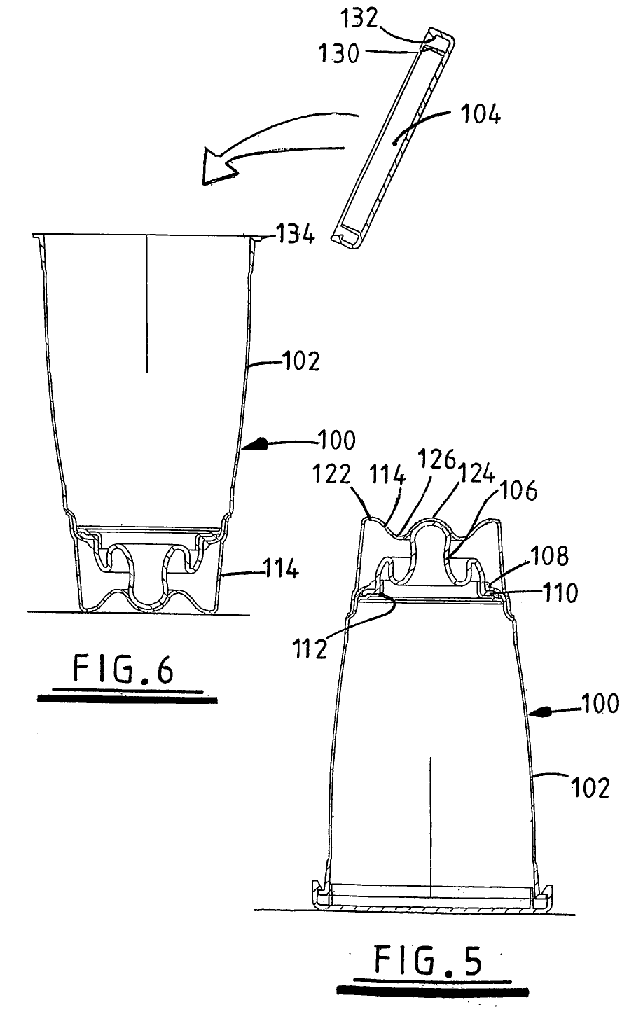

FIG. 5 shows another baby feeding bottle according to the invention;

FIG. 6 shows the bottle of FIG. 5 in position for filling;

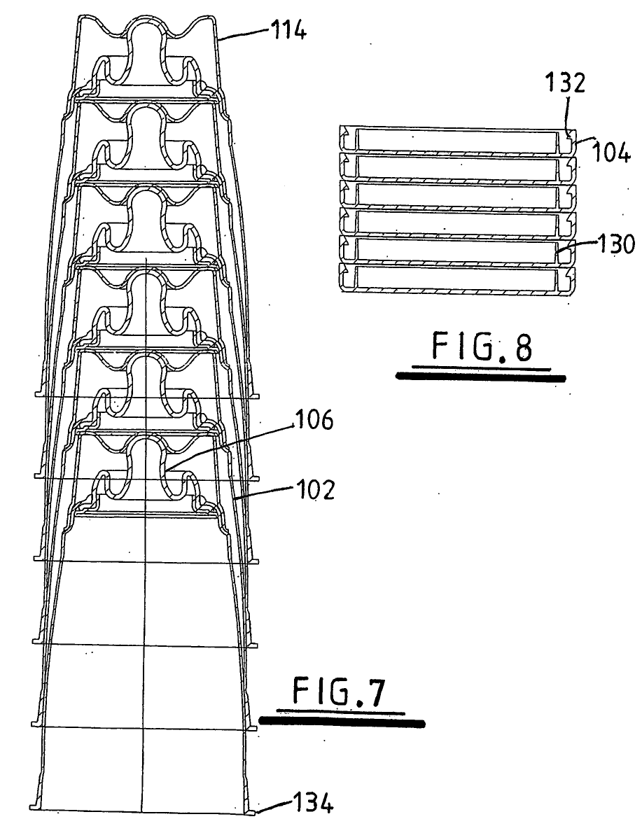

FIG. 7 shows bodies of bottles according to FIG. 5 in stacked formation;

FIG. 8 shows the lids for bottles of FIG. 5 in stacked form;

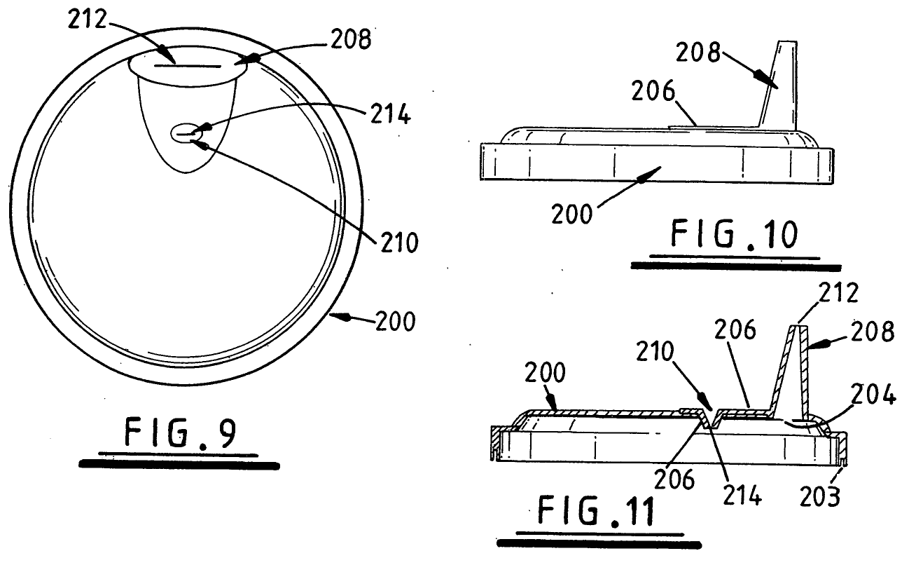

FIG. 9 is a top plan view of an alternative closure for a bottle of the invnetion;

FIG. 10 is a side view of the closure of FIG. 9; and

FIG. 11 is a section throguh the closure of FIG. 9.

Referring to FIGS. 1 to 3 of the accompanying drawings, a baby feeding bottle 10 comprises a container body 12 with an open top and a closure 14 that is a snap fit over the open end of the body 12. The body 12 has a lip 16 around its top edge and the closure has a rim 18 with an internal lip 20 that is a snap fit over the lip 16 of the container body. Below the lip 16 on the exterior of the container body is an annular rib 22 positioned, so that when the closure is in position, the rib interferes with attempts to re-open the bottle, so that the bottle is suitable for single usage prior to disposal for recycling.

The closure 14 has an internal depending annular wall 24 to form a seal against the inner surface of the container body, when the closure is in position on the body.

The closure has a generally central opening that has a teat 26 therein. The teat may be a separate item fitted to the closure, may be co-molded with closure or may be otherwise adhered to the closure. In the illustrated embodiment, the teat is held in place between a lip around the central aperture of the closure and a ring 28 pressed into the teat, so that the teat is trapped.

The teat is covered by a cap 30, that is a friction fit on the closure. The bottle container body is preferably made as a thin-walled injection molding, such as of polypropylene.

The container body and the closure/teat/cap combination are provided in stacks both for ease of packaging and for protection against contamination prior to use. The bottle components are to be packaged in sterile form, such as by means of irradiation. The container bodies are to be provided as a stack 40, such as shown in FIG. 2 and the closure/teat/cap combinations as a stack 42 as shown in FIG. 3.

In FIG. 2 it can be seen that the interior of each container is protected against contamination when being removed from the top of the stack by its close fit over the next container body down in the stack and because only its outer surface needs to be handled before filling. However to improve protection against contamination it is proposed, as shown in FIG. 4, to have each individual container body provided with an internal cover 44 that is sealed over the rim of each container body and extends into the container body 12, so as to allow close stacking as in the embodiment of FIG. 2 of the drawings. The cover preferably extends at least part way down the outside of the container body, so as to cover an area that will be handled when lifting a container body from a stack thereof. The internal covers may be made of polystyrene film but ideally any material used for the covers will be relatively thin and non-stick. When a container body is to be filled, it is removed from its stack and the internal cover peeled away.

The closure stack as shown in FIG. 3 of the drawings has the exterior of surface of each teat protected by its cap and its interior surface protected by the exterior surface of the cap of the underlying closure. Thus, when a closure is required, the top one from the stack is removed the teat of the next closure down remains protected form hand contact.

Both the container body and closure stacks are preferably provided in packs of say 10 or 12, the packs having been sealed and UV irradiated or otherwise sterilized.

Turning to FIGS. 5 to 8 of the accompanying drawings, there is provided another baby feeding bottle 100 according to the invention. The bottle 100 comprises a container body 102 that is formed open at both ends. Its intended bottom end is closed by a clip-on lid 104 and its intended top end has a teat 106 fitted. The top end of the body has sides turned inwards to form a ledge 108 under which flange 110 of the teat is held by means of a press-fit locking ring 112. The teat may alternatively be co-molded with the container body or adhered thereto by any other suitable means.

The teat 106 is protected by a push-fit cap 114 that locates over the upper sides of the body. The cap 114 is sized so as to depress the teat to a certain extent to reduce the overall height of the bottle to increase stacking density and the cap is also shaped so as to allow the bottle to be stood upright as shown in FIG. 6 of the drawings for filling. The cap has a top surface having a rim 122 and a central part 124 linked by an annular depressed part 126.

The clip-on lid 104 has an internal annular wall 130 sized to fit sealingly within the container body and an annular internal rib 132 that locates over an annular external rib 134 of the container body. It is envisaged that a rib will provided on the outer surface of the body just above the clip-on lid to inhibit removal thereof once fitted, so that the bottle can become effectively a single-use disposable bottle.

As in the previous embodiment it is intended that the components of the bottle 100 will be provided in stacks that are packaged in a sterile manner. Thus, as shown, the body and teat combinations are stacked inside each other. As with the previous embodiment it is envisaged that the internal surfaces of the body will be protected by internal covers in the same way. The clip-on lids will be stacked on top of each other as shown and each stack will be provided in as sterile package. The packages may be sterilized in any suitable way, such as by electron beam irradiation.

The container body is preferably thermo-formed from say polypropylene. The container body may alternatively be made by injection molding, vacuuming forming or blow molding.

In either of the illustrated embodiments the teats are preferably provided with bleed valves to allow for pressure equalization within the bottles as liquid is sucked out. A bleed valve preferably comprises a hole in the teat flange, wherein the hole has divergent sides from the inner to the outer side of the teat.

Finally, in FIGS. 9 to 11 of the accompanying drawings there is shown a closure 200 for a container for a feeding bottle of the type shown in FIGS. 1 and 3 of the accompanying drawings. The closure 200 has a main part with a lip 202 that has an annular slot 203 (not shown in detail) to locate on the rim of a container 12 in a similar manner to the closure 14 shown in FIG. 1. The main part has a two apertures therein, namely a first larger aperture 204 near an edge of the closure and a second smaller aperture nearer to the middle of the closure. Over the area of including these apertures is co-moulded a component 206 providing a spout 208 and a vent 210 for the closure. The main part of the closure is moulded from polypropylene and the component 206 is moulded from thermoplastic elastomer (TPE).

The spout 208 concides with the larger aperture 204 and the vent 210 coincides with the smaller aperture 206. The spout 208 has a generally oval section and has a slit opening 212 at its top. The vent 210 is also generally oval in section and extends through the closure. The vent also has a slit opening 214. The vent allows air to replace liquid in the container as the liquid is sucked out.

1-40. (canceled)

41. A feeding bottle for babies or young children comprising a container body and a closure therefor, wherein the container body before use has a cover protecting the interior thereof.

42. A feeding bottle as claimed in claim 41, wherein the bottle comprises components that are stackable in sets of the components.

43. A feeding bottle as claimed in claim 42, wherein the bottle comprising a container body and a closure therefor, is provided as a stack of container bodies one within the other and a stack of closures on top of each other.

44. A feeding bottle as claimed in claim 43, wherein the closure component includes a teat for the bottle.

45. A feeding bottle as claimed in claim 44, wherein the teat is a separable component.

46. A feeding bottle as claimed in claim 45 further comprising means for locking the teat in place.

47. A feeding bottle as claimed in claim 46, wherein the locking means comprises a locking ring to clamp a flange of the teat between the closure and the ring.

48. A feeding bottle as claimed in claim 44, wherein the teat is bonded or co-molded to the closure.

49. A feeding bottle as claimed in claim 44, wherein the teat is attached to one end of the container body and a closure is attachable to the opposite end of the body.

50. A feeding bottle as claimed in claim 44, wherein a cap is provided for protecting the teat.

51. A feeding bottle as claimed in claim 50, wherein the cap is a press-fit over the teat onto the closure or sides of the body.

52. A feeding bottle as claimed in claim 41, wherein the bottle has a closure having a drinking spout.

53. A feeding bottle as claimed in claim 52, wherein the spout has a slit for a drinking opening.

54. A feeding bottle as claimed in claim 52, wherein the spout is situated close to an edge of the closure.

55. A feeding bottle as claimed in claim 52, wherein the closure has a vent.

56. A feeding bottle as claimed in claim 55, wherein the vent is in the form of a slit.

57. A feeding bottle as claimed in claim 55, wherein the vent is in a depression of the closure.

58. A feeding bottle as claimed in claim 55, wherein the vent slit is shorter than the slit of the drinking spout.

59. A feeding bottle as claimed in claim 52, wherein the spout is co-molded onto the closure.

60. A feeding bottle as claimed in claim 59, wherein the vent is co-molded onto the closure.

61. A feeding bottle as claimed in claim 43, wherein the closure is a screw cap.

62. A feeding bottle as claimed in claim 43, wherein the closure is non-removable once the bottle has been filled.

63. A feeding bottle as claimed in claim 62, wherein the closure and container include a ratchet mechanism.

64. A feeding bottle as claimed in claim 43, wherein the closure is a snap-fit onto the body.

65. A feeding bottle as claimed in claim 64, wherein a formation is provided on the body to inhibit removal of the closure.

66. A feeding bottle as claimed in claim 65, wherein said formation is a rib or the like to inhibit levering off of the closure.

67. A feeding bottle as claimed in claim 66, wherein the rib extends outwards to be substantially coterminous with the outer extent of the closure.

68. A feeding bottle as claimed in any one of claim 43, wherein the closure is adapted or arranged to form a fluid tight seal with the container body.

69. A feeding bottle as claimed in claim 41, wherein the cover extends into the container body, whereby container bodies are stackable one within the other.

70. A feeding bottle as claimed in claim 41, wherein the cover is adhered to the rim of the container body at its open end.

71. A feeding bottle as claimed in claim 41, wherein the cover is made of flexible plastics material.

72. A feeding bottle as claimed in claim 41, wherein the cover is non-stick relative to the material of the container body.

73. A feeding bottle as claimed in claim 41, wherein the cover is made of polystyrene.

74. A container body for a feeding bottle for babies or young children, wherein the container body before use has a cover protecting the interior thereof.

75. A container body for a feeding bottle as claimed in claim 74, wherein the cover extends into the container body, whereby container bodies are stackable one within the other.

76. A container for a feeding bottle as claimed in claim 74, wherein the cover is adhered to the rim of the container body at its open end.

77. A container for a feeding bottle as claimed in claim 74, wherein the cover is made of flexible plastics material.

78. A container for a feeding bottle as claimed in claim 74, wherein the cover is non-stick relative to the material of the container body.

79. A container for a feeding bottle as claimed in claim 74, wherein the cover is made of polystyrene.
